(19) United States
(12) Patent Application Publication
(10) Pub. No.: US 2002/0038698 A1
(43) Pub. Date: Apr. 4, 2002

(54) Heat exchanger

(76) Inventors: Yong Kyu Kwon, Asan-si (KR); An Sik Choi, Asan-si (KR)

Correspondence Address: PENNIE AND EDMONDS, 1155 AVENUE OF THE AMERICAS, NEW YORK, NY, 100362711

(21) Appl. No.: 09/931,423

(22) Filed: Aug. 16, 2001

(30) Foreign Application Priority Data
Sep. 30, 2000 (KR) 2000-57656

(51) Int. Cl. F28F 1/00; B60H 3/00; B61D 27/00; B60H 1/00; B63J 2/00; B24D 13/00; B60H 1/26

(52) U.S. Cl. 165/42; 165/41; 454/69; 454/142

(57) ABSTRACT

In a heat exchanger including an evaporator, a blower, an air inlet unit and an air outlet unit, air is fed from outside into the inner part of the heat exchanger through the air inlet unit and then the air flows toward the blower through a first predetermined portion of the evaporator to thereby supply first heat-exchanged air and thereafter, the first heat-exchanged air is fed to the air outlet unit through a second predetermined portion of the evaporator by the blowing operation of the blower to thereby supply second heat-exchanged air.

### FIELD OF THE INVENTION

The present invention relates to a heat exchanger; and, more particularly, to a heat exchanger for use in an automobile air conditioner.

### BACKGROUND OF THE INVENTION

A conventional heat exchanger for use in, e.g., an automobile air conditioner usually includes a condenser for condensing a compressed coolant supplied from a compressor, an evaporator for supplying heat-exchanged cooled air to a duct connected to an air outlet unit of an evaporator case and a blower for feeding the heat-exchanged cooled air through the outlet unit of the evaporator case into a passenger's compartment, e.g., of an automobile. As is well known in the art, the evaporator usually has an evaporator coil for the flow of a coolant and a number of evaporator fins attached thereto for facilitating heat exchange between the coolant flowing through the evaporator coil and the air flowing through the heat exchanger, e.g., an air conditioner.

In the conventional heat exchanger, when a condensed coolant is fed to the evaporator coil through an expansion valve thereof, the evaporator absorbs heat through the evaporator fins from air surrounding the evaporator to thereby perform cooling operation on the air. The cooled air is fed to the passenger's compartment, e.g., of the automobile by blowing operation of the blower.

In the conventional heat exchanger, after air is incorporated in an air inlet grille of the evaporator, heat exchange is performed on this air by the evaporator to thereby feed the heat-exchanged air, i.e., cooled air to the air outlet unit of the heat exchanger through a blower. As a result, this heat-exchanged air is fed through the air outlet unit of the evaporator case into a passenger's compartment, e.g., of the automobile.

For example, FIG. 1A shows a schematic view of a conventional heat exchanger 100. FIG. 1B illustrates a schematic cross sectional view of a conventional heat exchanger 100 taken along a line X-X in FIG. 1A. The conventional heat exchanger 100 includes an evaporator 2, blowers 4 and 4′, guide units 3 and 3′ and air outlet units 6 and 6′ accommodated in an evaporator case 1. In FIGS. 1A and 1B, arrows represent flows of air.

First, air is fed from above and below into the inner part of the heat exchanger 100 through the blowers 4 and 4′ as shown in FIG. 1A. The air is fed to the evaporator 2 by blowing operation of the blowers 4 and 4′, respectively. The evaporator 2 performs heat-exchange operation on the air, thereby supplying heat-exchanged air into a passenger's compartment (not shown), e.g., of an automobile.

Since, however, in the conventional heat exchanger 100, heat exchange operation on the air from supplied outside into the evaporator 2 is performed by flowing the air through the evaporator 2 only once, heat exchange capability is limited. Hence, in order to increase the heat exchange capacity thereof, the capacity of the evaporator 2 should be increased. This increases the volume of the heat exchanger 100 to thereby exact cost and deteriorate the heat exchange efficiency thereof.

### SUMMARY OF THE INVENTION

It is, therefore, an object of the present invention to provide a heat exchanger for use in an automobile air conditioner for performing heat-exchange operation by flowing air from outside through the evaporator to supply heat-exchanged air and then performing heat-exchange operation on the heat-exchanged air through the evaporator once more, thereby enhancing heat exchange efficiency and decreasing the volume of the heat exchanger.

In accordance with a preferred embodiment of the present invention, there is provided a heat exchanger comprising:

an evaporator;

a blower;

an air inlet unit; and

an air outlet unit,

wherein air is fed from outside into the inner part of the heat exchanger through the air inlet unit and then the air flows toward the blower through a first predetermined portion of the evaporator to thereby supply first heat-exchanged air and thereafter, the first heat-exchanged air is fed to the air outlet unit through a second predetermined portion of the evaporator by the blowing operation of the blower to thereby supply second heat-exchanged air.

### BRIEF DESCRIPTION OF THE DRAWINGS

The above and other objects and features of the present invention will become apparent from the following description of preferred embodiments given in conjunction with the accompanying drawings, in which:

FIGS. 1A and 1B show schematic views of a conventional heat exchanger;

FIG. 2 depicts a schematic view of a heat exchanger in accordance with a preferred embodiment of the present invention; and

FIG. 3 illustrates a schematic view of a heat exchanger in accordance with another preferred embodiment of the present invention.

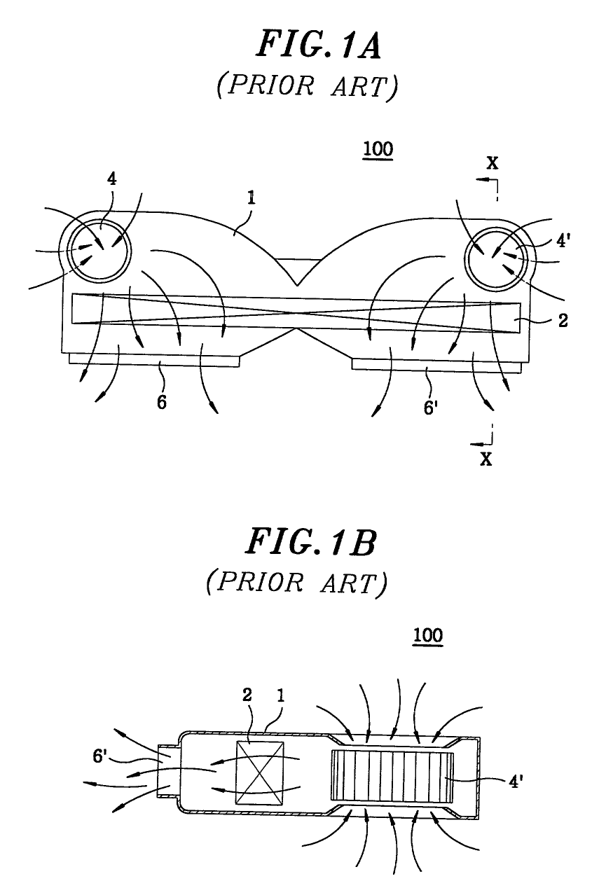

### DETAILED DESCRIPTION OF THE PREFERRED EMBODIMENTS

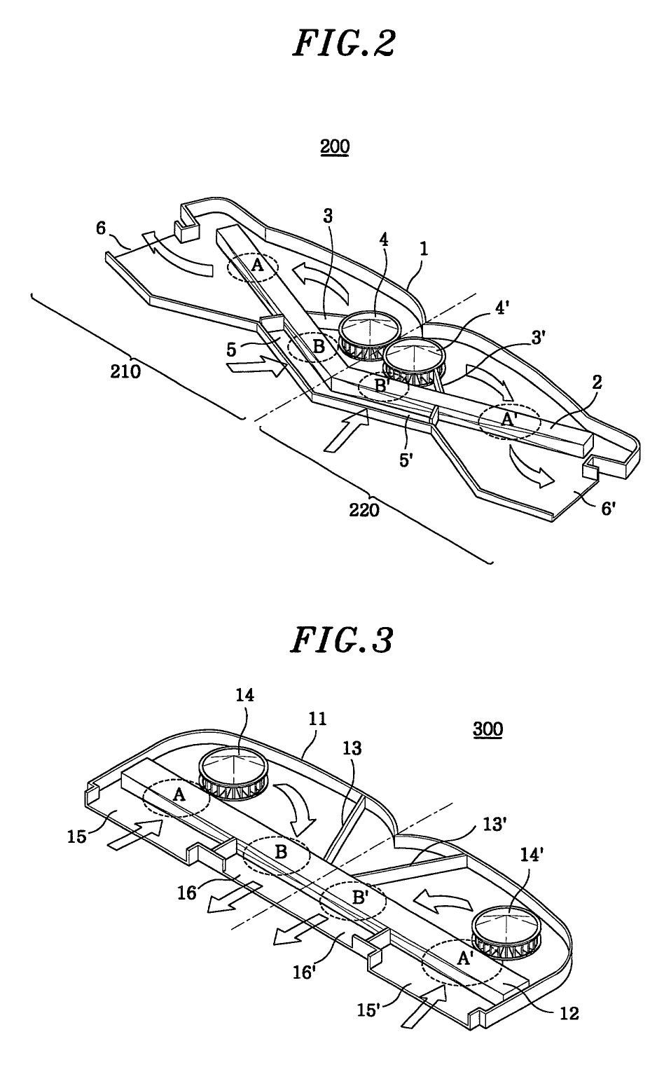

FIG. 2 depicts a schematic view of a heat exchanger 200 in accordance with a preferred embodiment of the present invention. The heat exchanger 200 has two symmetrical parts, i.e., a left half part 210 and a right half part 220 as shown in FIG. 2.

The heat exchanger 200 includes air inlet units 5 and 5′, an evaporator 2, guide units 3 and 3′, blowers 4 and 4′ and air outlet units 6 and 6′ accommodated in an evaporator case 1. In this preferred embodiment of the present invention, the blowers 4 and 4′ are located opposite to the air inlet units and the air outlet units with regard to the evaporator 2 as shown in FIG. 2. Further, the blowers 4 and 4′, the air inlet units 5 and 5′ and the air outlet units 6 and 6′ are arranged horizontally on a substantially same plane as shown in FIG. 2. In FIG. 2, arrows represent flows of air.

In the heat exchanger 200, air is first fed from outside into the inner part of the heat exchanger 200 through the air inlet units 5 and 5′, respectively. Then the air flows toward the blowers 4 and 4′ through first predetermined portions, e.g., center portions “B” and “B′” of the evaporator 2 to thereby supply first heat-exchanged air, respectively.

The first heat-exchanged air flows through second predetermined portions, e.g., end portions “A” and “A′” of the evaporator 2 by blowing operation of the blowers 4 and 4′ to thereby supply second heat-exchanged air toward the air outlet units 6 and 6′, respectively. Thereafter, the second heat-exchanged air is supplied to a passenger's compartment (not shown), e.g., of an automobile.

In this preferred embodiment of the present invention, the air inlet units 5 and 5′ are located in front of the center portions “B” and “B′” of the evaporator 2; and the air outlet units 6 and 6′ are located in front of the end portions “A” and “A′” of the evaporator 2 as shown in FIG. 2.

FIG. 3 illustrates a schematic view of a heat exchanger 300 in accordance with another preferred embodiment of the present invention. The heat exchanger 300 includes air inlet units 15 and 15′, an evaporator 12, guide units 13 and 13′, blowers 14 and 14′ and air outlet units 16 and 16′ accommodated in an evaporator case 11. In FIG. 3, arrows represent flows of air.

In this another preferred embodiment of the present invention, the blowers 14 and 14′ are located opposite to the air inlet units and the air outlet units with regard to the evaporator 12 as illustrated in FIG. 3. Further, the blowers 14 and 14′, the air inlet units 15 and 15′ and the air outlet units 16 and 16′ are arranged horizontally on a substantially same plane as illustrated in FIG. 3.

In the heat exchanger 300, air is first fed from outside into the inner part of the heat exchanger 300 through the air inlet units 15 and 15′, respectively. Then the air flows toward the blowers 14 and 14′ through first predetermined portions, e.g., end portions “A” and “A′” of the evaporator 2 to thereby supply first heat-exchanged air, respectively.

The first heat-exchanged air is fed to the air outlet units 6 and 6′ through second predetermined portions, e.g., end portions “B” and “B′” of the evaporator 2 by blowing operation of the blowers 14 and 14′ to thereby supply second heat-exchanged air toward the air outlet units 16 and 16′, respectively. Thereafter, the second heat-exchanged air is supplied to a passenger's compartment (not shown), e.g., of an automobile.

In this another preferred embodiment of the present invention, the air inlet units 15 and 15′ are located in front of the end portions “A” and “A′” of the evaporator 12; and the air outlet units 16 and 16′ are located in front of the center portions “B” and “B′” of the evaporator 12 as illustrated in FIG. 3.

It should be noted that in the above-mentioned preferred embodiments of the present invention, the guide units 3, 3′, 13 and 13′ guide flow of the first heat-exchanged air.

While the present invention has been described with respect to certain preferred embodiments only, other modifications and variations may be made without departing from the spirit and scope of the present invention as set forth in the following claims.

What is claimed is:

1. A heat exchanger comprising;
an evaporator;
a blower;
an air inlet unit; and
an air outlet unit,
wherein air is fed from outside into the inner part of the heat exchanger through the air inlet unit and then the air flows towards the blower through a first predetermined portion of the evaporator to thereby supply first heat-exchanged air and thereafter, the first heat-exchanged air is fed to the air outlet unit through a second predetermined portion of the evaporator by the blowing operation of the blower to thereby supply second heat-exchanged air.

2. The heat exchanger according to claim 1, wherein the blower is located opposite to the air inlet unit and the air outlet unit with regard to the evaporator, wherein the blower, the air inlet unit and the air outlet unit are arranged horizontally on a substantially same plane.

3. The heat exchanger according to claim 2, wherein the air inlet unit is located in front of the first predetermined portion of the evaporator, and the air outlet unit is located in front of the second predetermined portion of the evaporator.

4. The heat exchanger according to claim 3, wherein the first predetermined portion and the second predetermined portion are a center portion and an end portion of the evaporator, respectively.

5. The heat exchanger according to claim 3, wherein the first predetermined portion and the second predetermined portion are an end portion and a center portion of the evaporator, respectively.

6. The heat exchanger according to claim 1, further comprising a guide unit for guiding flow of the first heat-exchanged air.

7. A heat exchanger comprising:
an evaporator having a first predetermined portion and a second predetermined portion;
at least one blower;
at least one air inlet; and
at least one air outlet,
wherein the first predetermined portion of the evaporator is disposed between the at least one air inlet and the blower and the second predetermined portion of the evaporator is disposed between the blower and the at least one air outlet.

8. The heat exchanger according to claim 7, wherein the at least one air inlet and the at least one air outlet are arranged horizontally on substantially the same plane.

9. The heat exchanger according to claim 7, wherein the at least one air inlet is located in front of the first predetermined portion of the evaporator and the at least one air outlet is located in front of the second predetermined portion of the evaporator.

10. The heat exchanger according to claim 7, wherein the first predetermined portion and the second predetermined portion are a center portion and an end portion of the evaporator, respectively.

11. The heat exchanger according to claim 7, wherein the first predetermined portion and the second predetermined portion are a center portion and an end portion of the evaporator, respectively.

12. Theat exchanger according to claim 7, further comprising a guide unit for directing air flow from the at least one air inlet through the first predetermined portion of the evaporator to the blower.

13. The heat exchanger according to claim 7, further comprising a guide unit for directing air flow from the blower through the second predetermined portion of the evaporator to the at least one air outlet.

14. A method of conditioning air comprising the steps of:
(a) providing the heat exchanger of claim 7 ;
(b) providing unconditioned air into the at least one air inlet;
(c) feeding at least a portion of the unconditioned air through a first predetermined portion of the evaporator towards the blower;
(d) directing at least a portion of the first heat-exchanged air from the blower through a second predetermined portion of the evaporator.
